(19) United States
(12) Patent Application Publication
(10) Pub. No.: US 2007/0195076 A1
(43) Pub. Date: Aug. 23, 2007

(54) Apparatus and Method for Adaptively Adjusting Display Parameters

(76) Inventors: Limai Wan, Shenzhen (CN); Li Yao, Shenzhen (CN)

Correspondence Address: PILLSBURY WINTHROP SHAW PITTMAN LLP, P.O. BOX 10500, MCLEAN, VA, 22102, US

(21) Appl. No.: 11/615,871

(22) Filed: Dec. 22, 2006

(30) Foreign Application Priority Data
Feb. 23, 2006 (CN) 200610033913.9

(51) Int. Cl. G09G 5/00

(52) U.S. Cl. 345/204

(57) ABSTRACT

The present invention provides an apparatus and a method for adaptively adjusting display parameters. With the apparatus and the method, an adaptive adjustment can be performed on the display parameters from the host for displaying image signals automatically according to the display attributes information of the display, so as to present the image on the display clearly.

### FIELD OF THE INVENTION

The invention relates generally to an apparatus and method for displaying image signals, and more particularly, to an apparatus and method for adaptively adjusting display parameters.

### BACKGROUND OF THE INVENTION

In practice of clinical medicine, monitors play an important role in the diagnosis procedure since it can dynamically display multiple physiological parameters of human bodies.

A monitor is composed of a host for processing the detected physiological parameters to generate image signals to be displayed which are also called as display signals to be displayed on the screen of the display; and a display for displaying the image signals on a screen, so as to allow medical persons to observe the patients in treatment.

FIG. 1 is a schematic diagram of a conventional monitor. As shown in FIG. 1, the monitor comprises a Host 100 and a Display 200. The Host 100 further comprises: a Data Source 5, such as an embedded processor, for generating graphic or image data to be displayed based on detected physiological parameters, and converting the graphic data into image information for display memory; and a Display Control Module 30, which is composed of a Display Memory Read/Write Module 32 and a Display Timing Control Module 35. The Display Memory Read/Write Module 32 stores the image information corresponding to pixels on display screen in the Display Memory 40 according to mapping addresses. The Display Timing Control Module 35 controls the Display Memory Read/Write Module 32 to read the image information from the Display Memory 40, and controls to display the image information on the screen of the Display 200 via an Interface Module 70 according to a certain display timing.

In application, many devices including monitors usually use displays provided by display device manufacturers. Especially for embedded devices, the display attributes information of the display, such as clock frequency, display timing and resolution, has been set at time of manufacture. Most display device manufacturers employ the Extended Display Identification Data (EDID) specification to store the display attributes information in the built-in Electrically Programmable Read-Only Memory (EPROM) of the display.

In practice, however, display parameters, such as horizontal scanning parameters and vertical scanning parameters, from the host for displaying image signals may be inconsistent with the display attributes information of the display. This may deteriorate the image display quality, and even may result in incorrect display of the image.

### SUMMARY OF THE INVENTION

Therefore, an object of the present invention is to provide an apparatus and a method for adaptively adjusting display parameters. With the apparatus and the method, an adaptive adjustment can be performed on the display parameters from the host for displaying image signals automatically according to the display attributes information of the display, so as to present the image on the display clearly.

The present invention provides an apparatus for adaptively adjusting display parameters, comprising: a reading module, for reading display attributes information from a connectable display; a memory, for storing the display parameters provided by a connectable configuring module based on the display attributes information; and a control module, for reading the stored display parameters and controlling display timing for image signals to be displayed on the display according to the read display parameters.

The present invention provides a device for displaying image signals, comprising: a reading module, for reading display attributes information from a connectable display; a configuring module, for providing corresponding display parameters based on the display attributes information; a memory, for storing the display parameters; and a control module, for reading the stored display parameters and controlling display timing for image signals to be displayed on the display according to the read display parameters.

The present invention provides a method for adaptively adjusting display parameters, comprising steps of: reading display attributes information from a connectable display; storing the display parameters for displaying image signals, the display parameters are configured based on the display attributes information; and controlling display timing for image signals to be displayed on the display according to the display parameters.

The present invention provides a method for displaying image signals, comprising steps of: reading display attributes information from a connectable display; providing corresponding display parameters for displaying the image signals based on the display attributes information; storing the display parameters; reading the stored display parameters; and controlling display timing for the image signals to be displayed on the display according to the read display parameters.

Other objects and aspects of the invention will become more apparent and easy to be understood from the following description with reference to the accompanying drawings and with general understanding of the invention.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a schematic diagram of a conventional monitor;

FIG. 2 is a schematic diagram of a monitor according to an embodiment of the invention;

FIG. 3A is a schematic timing diagram for horizontal scanning parameters in the embodiment of the invention;

FIG. 3B is a schematic timing diagram for vertical scanning parameters in the embodiment of the invention;

FIG. 4 is a flow chart of a method for adaptively adjusting the display parameters according to the embodiment of the invention.

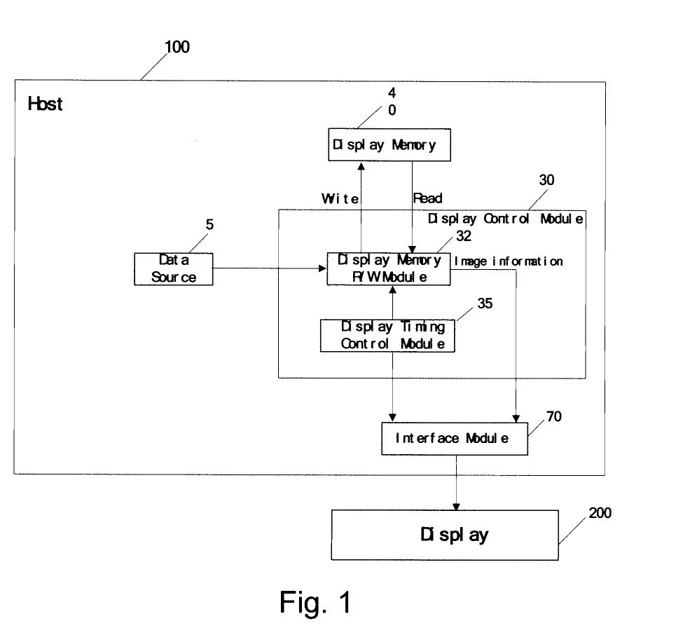

Throughout all the above drawings, like reference numerals will be understood to refer to like, similar or corresponding features or functions.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

According to certain broad and general aspects, the method for adaptively adjusting display parameters of the present invention may automatically configure the display parameters by reading out the display attributes information stored in the display, such that the image signals to be displayed based on the display parameters can be adaptively adjusted according to display timing corresponding to the display attributes information, so as to make the image clearly displayed on the display.

Various embodiments of the process of the method and the structure of apparatus for implementing the method will be made understood to those skilled in the art below with reference to the drawings.

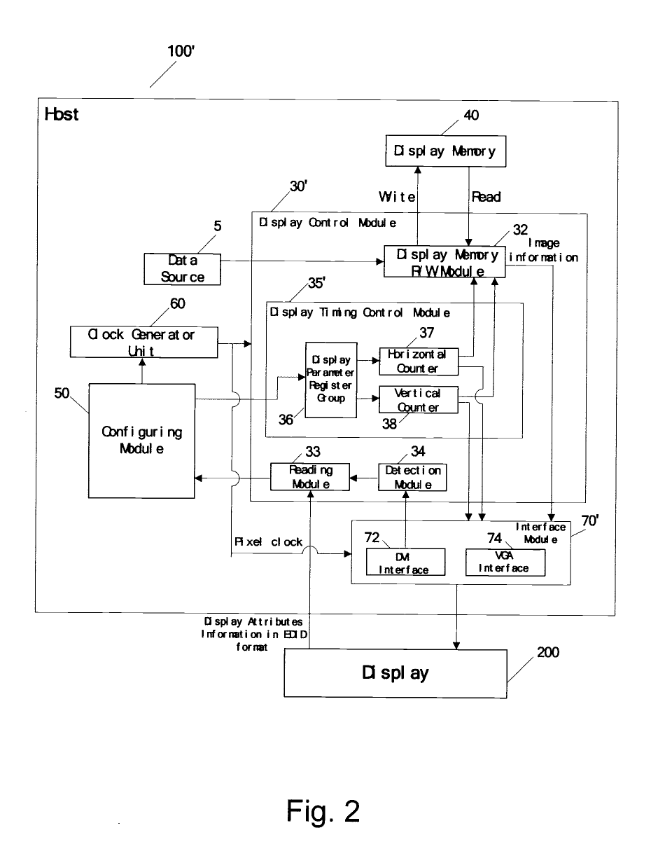

As shown in FIG. 2, a monitor according to an embodiment of the invention may be provided a Reading Module 33 in the Display Control Module 30′. The Reading Module 33 may communicate with a Display 200 to read out the display attributes information stored in the EPROM of Display 200. In a preferred embodiment, the Reading Module 33 may read the display attributes information via a Display Data Channel (DDC).

Moreover, according to the preferred embodiment, the Reading Module 33 can attempt to read the display attributes information not only when the host is powered on, but also during the host's operation.

Particularly, during the host's operation, when an external display is connected to the host via a Digital Visual Interface (DVI) 72 in the Interface Module 70′, a Detection Module 34 may determine that a display is connected according to a Hot Plugging Detect Signal received from the DVI interface 72, and then generate a reading signal which is supplied to the Reading Module 33. Once receiving the reading signal, the Reading Module 33 may read the display attributes information of the currently connected display via the DDC channel. When an external display is connected to the host via a VGA interface 74, there will be no Hot Plugging Detect Signal generated. The Detection Module 34 may generate a reading signal at predetermined time interval, so as to control the Reading Module 33 to read the display attributes information via the DDC channel. When the Detection Module 34 determines the read display attributes information is valid by identifying a certain flag in the display attributes information, it can be determined that a VGA display is connected currently.

In this way, the Reading Module 33 may acquire the display attributes information of the connected display in real time. Since the display attributes information is usually stored in a standard data format, such as EDID specification, a Configuring Module 50 in the host may automatically adaptively adjust the display parameters for displaying the image signals based on the display attributes information when the Reading Module 33 provides the read display attributes information to the Configuring Module 50, such that the display parameters corresponding to the display attributes information may be provided to the Display Control Module 30′.

For displaying image signals on the display screen, pixel clock is a fundamental element, which may relate to the control of the resolution and display timing for the display. Therefore, a clock frequency suitable for the display may often be included in the display attributes information of the display. The Configuring Module 50 may control a Clock Generator Unit 60 to generate, based on the clock, a pixel clock as a reference clock for displaying image signals on the display. In general, the Clock Generator Unit 60 may be able to generate clock signals of multiple frequencies. The Configuring Module 50 may select, according to the clock applicable to the current display, a suitable clock signal to provide to the Display Control Module 30′ and the Interface Module 70′, respectively.

The Configuring Module 50 may also determine the display parameters used for displaying image signals based on the resolution and display timing in the display attributes information, as well as determine the corresponding pixel clock based on the clock applicable to the display. The display parameters include horizontal scanning parameters and vertical scanning parameters. The Configuring Module 50 stores the values of the determined display parameters into a Memory 36 in the Display Timing Control Module 35′ respectively, for using by the Display Timing Control Module 35′ to generate the display timing for displaying image signals, wherein the Memory 36 may be composed of a group of registers for storing the display parameters.

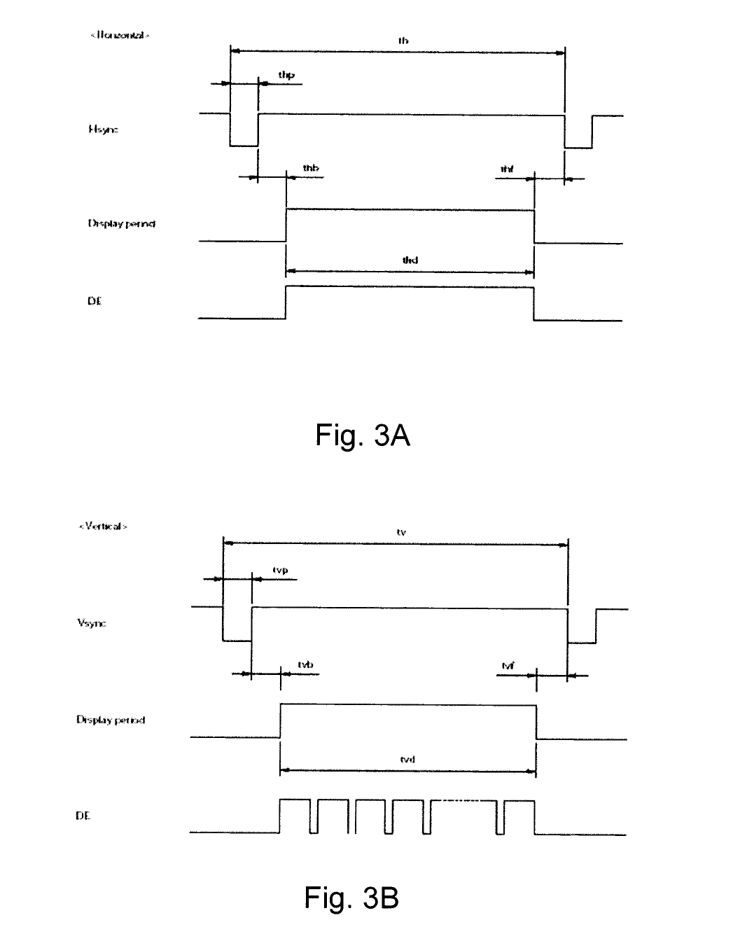

The display parameters will be explained with reference to the FIG. 3A and FIG. 3B thereafter.

As shown in FIG. 3A, a Horizontal Period denoted by th may include a Horizontal Active Duration and a Horizontal Blanking Duration.

The Horizontal Active Duration has a time length which equals to the number of pixels in a horizontal line multiplying a clock period. When the signal DE for indicating a Display Duration in FIG. 3A is in high level, it represents the Horizontal Active Duration. Accordingly, the value of the register, which stores the number of clock periods occupied by the Horizontal Active Duration, equals to the number of horizontal pixels. The number of horizontal pixels, i.e, the horizontal resolution of the display, is denoted by thd in FIG. 3A.

The Horizontal Blanking Duration is an interval from the end of a Horizontal Active Duration to the start of next Horizontal Active Duration. The Horizontal Blanking Duration includes a Horizontal Front Porch, a Horizontal Sync Pulse Width and a Horizontal Back Porch. The Horizontal Front Porch, i.e. the Horizontal Sync Offset, is an interval from the end of a Horizontal Active Duration to the start of a Horizontal Sync signal, and occupies the number thf of clock periods; the Horizontal Sync Pulse Width is the number thp of clock periods occupied by the Horizontal Sync signal; the Horizontal Back Porch is an interval from the end of a Horizontal Sync Pulse Width to the start of next Horizontal Active Duration, and occupies the number thb of clock periods. The numbers thf, thp and thb of clock periods occupied by the Horizontal Front Porch, the Horizontal Sync Pulse Width and the Horizontal Back Porch respectively are also stored in corresponding registers in the Display Parameter Register Group 36.

FIG. 3B shows the display parameters related to Vertical Period. The display parameters for Horizontal Period are in unit of pixel, and the display parameters for Vertical Period are in unit of line.

As shown in FIG. 3B, similar to the Horizontal Period, the Vertical Period denoted by tv may include a Vertical Active Duration and a Vertical Blanking Duration.

The Vertical Active Duration has a time length which equals to the number of lines displayed in a screen multiplying the Horizontal Period th. When the signal DE for indicating Display Duration in FIG. 3B is in high level, it represents the Vertical Active Duration. Accordingly, the value of the register, that stores the number of horizontal periods occupied by the Vertical Active Duration, equals to the number of vertical pixels. The number of vertical pixels, ie., the vertical resolution of the display, is denoted by tvd in FIG. 3B. The value of tvd corresponds to the number of active display lines in a field.

The Vertical Blanking Duration is an interval from the end of a Vertical Active Duration to the start of next Vertical Active Duration. The Vertical Blanking Duration includes a Vertical Front Porch, a Vertical Sync Pulse Width and a Vertical Back Porch. The Vertical Front Porch, i.e. the Vertical Sync Offset, is an interval from the end of a Vertical Active Duration to the start of the Vertical Sync signal, and occupies the number tvf of horizontal periods; the Vertical Sync Pulse Width is the number tvp of horizontal periods occupied by the Vertical Sync signal; the Vertical Back Porch is an interval from the end of a Vertical Sync Pulse Width to the start of next Vertical Active Duration, and occupies the number tvb of horizontal periods. The numbers tvf, tvp and tvb of horizontal periods occupied by the Vertical Front Porch, the Vertical Sync Pulse Width and the Vertical Back Porch respectively are also stored in corresponding registers in the Display Parameter Register Group 36.

The Display Timing Control Module 35′ may set count values for a Horizontal Counter 37 and a Vertical Counter 38 respectively based on the horizontal scanning parameters and the vertical scanning parameters, after the Configuring Module 50 determines the above display parameters based on the resolution and display timing in the display attributes information, and stores the display parameters into the Display Parameter Register Group 36. Moreover, the Display Timing Control Module 35′ may also set state transfer conditions for Horizontal Sync State Machine and Vertical Sync State Machine (not shown) to control horizontal scan process and vertical scan process, according to the values of registers corresponding to the parameters about Horizontal Active Duration and Horizontal Blanking Duration in the horizontal scanning parameters, as well as the values of registers corresponding to the parameters about Vertical Active Duration and Vertical Blanking Duration in the vertical scanning parameters. While the states of the Horizontal Sync State Machine and Vertical Sync State Machine roll over with the count values of the Horizontal Counter 37 and the Vertical Counter 38, the display timing for displaying image signals is generated from the Display Timing Control Module 35′.

According to the generated display timing, the Display Timing Control Module 35′ controls the Display Memory Read/Write Module 32 to read out the image information to be displayed from the Display Memory 40, and controls to display the image information on the screen of the Display 200 via the Interface Module 70′.

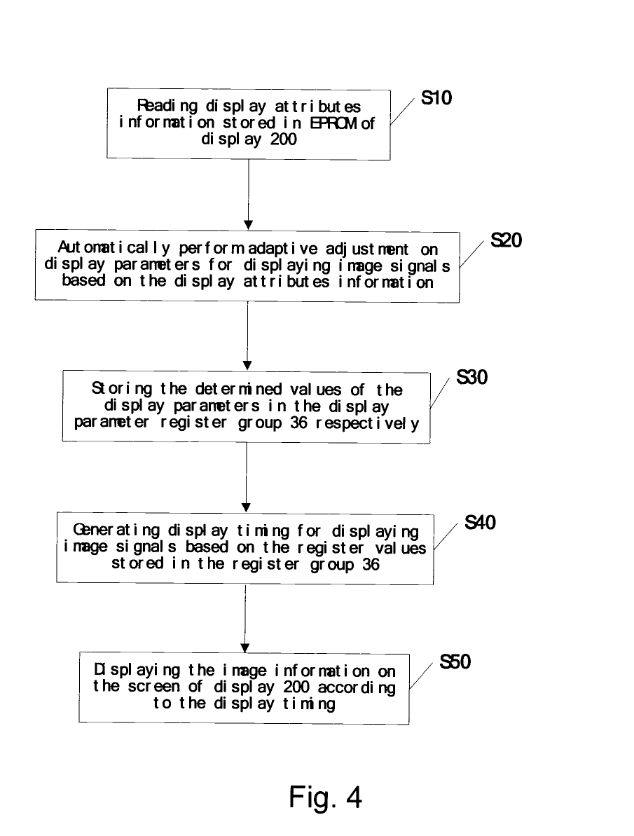

FIG. 4 is a flow chart of the method for adaptively adjusting the display parameters which may be implemented in the monitor of FIG. 2.

First, the Reading Module 33 may read out the display attributes information stored in the EPROM of the Display 200 via the DDC channel (step S10). As described in the above preferred embodiment, the Reading Module 33 can read the display attributes information not only when the host is powered on, but also during the host's operation once detecting a Hot Plugging Detect Signal from the DVI interface or detecting the valid display attributes information.

Next, the Configuring Module 50 may automatically make an adaptive adjustment on the display parameters for displaying image signals according to the display attributes information (step S20). Particularly, the Configuring Module 50 may select a suitable clock signal based on the clock used by the current display, so as to provide it to the Display Control Module 30′ and the Interface Module 70′, respectively. The Configuring Module 50 may determine the display parameters including the horizontal scanning parameters and the vertical scanning parameters used in displaying the image signals, according to the resolution and display timing in the display attributes information, so as to provide the Display Control Module 30′ with the display parameters corresponding to the display attributes information.

After the corresponding display parameters are determined based on the display attributes information, the Configuring Module 50 may store the values of the display parameters in the Display Parameter Register Group 36 in the Display Timing Control Module 35′, respectively (step S30).

Then, the Display Timing Control Module 35′ may generate the display timing for displaying the image signals according to the register values stored in the Register Group 36 (step S40). The step S40 for generating the display timing includes: setting the count values for the Horizontal Counter 37 and the Vertical Counter 38 respectively according to the horizontal scanning parameters and the vertical scanning parameters; and setting the state transfer condition for the Horizontal Sync State Machine and Vertical Sync State Machine according to the values of the registers corresponding to parameters about the Horizontal Active Duration and Horizontal Blanking Duration in the horizontal scanning parameters, as well as to the values of the registers corresponding to parameters about the Vertical Active Duration and Vertical Blanking Duration in the vertical scanning parameters. While the states of the Horizontal Sync State Machine and Vertical Sync State Machine roll over with the count values of the Horizontal Counter 37 and the Vertical Counter 38, the display timing for displaying image signals is generated.

According to the generated display timing, the Display Timing Control Module 35′ controls the Display Memory Read[Write Module 32 to read the image information to be displayed from the Display Memory 40, and controls to display the image information on the screen of Display 200 via the Interface Module 70′ (step S50).

Certain beneficial effects according aspects of embodiments of the present invention will now be described.

The method and apparatus for adaptively adjusting the display parameters of the present invention utilizes a fact that the display attributes information in the display conforms to certain data specification, and reads the display attributes information via the DDC channel, such that the host may automatically make an adaptive adjustment on the display parameters used for displaying image signals based on the display attributes information, and may configure the Display Parameter Register Group for generating the display timing with the adjusted display parameters. Therefore, the image signals displayed according to the display parameters may be clearly presented on the screen of the display.

Furthermore, according to an embodiment of the present invention, the information associated with the connection of an external display to the host may be acquired in time by the Hot Plugging Detect Signal from the DVI interface or by detecting whether the periodically read display attributes information is valid or not. Therefore, the present invention can acquire the display attributes information of the currently connected display in real time, and adaptively adjust the display parameters for displaying image in time.

The method and apparatus for adaptively adjusting the display parameters of the present invention is applicable not only to the monitor composed of separate host and display, but also to the monitor in which the host and the display are embedded integrally.

The method and apparatus for adaptively adjusting the display parameters of the present invention may be implemented by software, hardware, as well as the combination thereof.

Moreover, the method and apparatus for adaptively adjusting the display parameters of the present invention is applicable not only to the monitor, but also to other devices in which the combination of display and host is employed.

It is to be understood by those skilled in the art that various improvements and modifications may be made to the method and apparatus for adaptively adjusting the display parameters disclosed above in the present invention without departing from the basis of the present invention. Therefore, the protection scope of the present invention is to be defined by the attached claims.

Although the present invention is described with reference to the preferred embodiment, but it is not intended to limit the present invention in the specific embodiment illustrated herein. And the scope of the present invention is to be defined by the attached claims. In the claims, the term “comprising” and “comprise” is not intended to exclude other elements and steps. Moreover, although listed separately, multiple apparatuses, elements and steps may also be implemented with a single unit or processor. Moreover, although separate features may be included in respective claims, the features may be beneficially combined, and the inclusion in respective claims does not imply the combination of the features is unfeasible and/or disadvantageous.

What is claimed is:

1. An apparatus for adaptively adjusting display parameters, comprising:
a reading module, for reading display attributes information from a connectable display; a memory, for storing the display parameters provided by a connectable configuring module based on the display attributes information; and
a control module, for reading the stored display parameters and controlling display timing for image signals to be displayed on the display according to the read display parameters.

2. The apparatus for adaptively adjusting display parameters as claimed in claim 1, wherein the display attributes information includes at least one of clock, display timing and resolution.

3. The apparatus for adaptively adjusting display parameters as claimed in claim 2, wherein the display parameters include at least one of horizontal scanning parameters and vertical scanning parameters generated by the configuring module based on the display attributes information.

4. The apparatus for adaptively adjusting display parameters as claimed in claim 3, wherein the horizontal scanning parameters include Horizontal Resolution, Horizontal Active Duration, Horizontal Blanking Duration, Horizontal Sync Offset, and Horizontal Sync Pulse Width; the vertical scanning parameters include Vertical Resolution, Vertical Active Duration, Vertical Blanking Duration, Vertical Sync Offset and Vertical Sync Pulse Width.

5. The apparatus for adaptively adjusting display parameters as claimed in claim 4, wherein the control module comprises:
a horizontal counter, for controlling horizontal scan process based on the horizontal scanning parameters; and
a vertical counter, for controlling vertical scan process based on the vertical scanning parameters.

6. The apparatus for adaptively adjusting display parameters as claimed in claim 2, further comprising a clock generator unit, for providing a reference clock for displaying the image signals on the display, based on said clock.

7. The apparatus for adaptively adjusting display parameters as claimed in claim 1, further comprising a detection module, for generating a reading signal once receiving a Hot Plugging Detect Signal from a Digital Visual Interface (DVI), to control the reading module to read the display attributes information.

8. The apparatus for adaptively adjusting display parameters as claimed in claim 1, further comprising a detection module, for generating a reading signal at predetermined time interval, to control the reading module to read the display attributes information; the detection module determines whether the read display attributes information is valid or not by identifying a certain flag in the display attributes information.

9. The apparatus for adaptively adjusting display parameters as claimed in claim 1, wherein the reading module reads the display attributes information via a Display Data Channel (DDC).

10. The apparatus for adaptively adjusting display parameters as claimed in claim 1, wherein the display attributes information conforms to an Extended Display Identification Data (EDID) specification.

11. A device for displaying image signals, comprising:
a reading module, for reading display attributes information from a connectable display; a configuring module, for providing corresponding display parameters based on the display attributes information;
a memory, for storing the display parameters; and
a control module, for reading the stored display parameters and controlling display timing for image signals to be displayed on the display according to the read display parameters.

12. The device for displaying image signals as claimed in claim 11, wherein the display attributes information includes at least one of clock, display timing and resolution.

13. The device for displaying image signals as claimed in claim 12, wherein the display parameters include at least one of horizontal scanning parameters and vertical scanning parameters, and the horizontal scanning parameters include Horizontal Resolution, Horizontal Active Duration, Horizontal Blanking Duration, Horizontal Sync Offset and Horizontal Sync Pulse Width; the vertical scanning parameters include Vertical Resolution, Vertical Active Duration, Vertical Blanking Duration, Vertical Sync Offset and Vertical Sync Pulse Width.

14. The device for displaying image signals as claimed in claim 13, wherein the control module comprises:
a horizontal counter, for controlling horizontal scan process based on the horizontal scanning parameters; and
a vertical counter, for controlling vertical scan process based on the vertical scanning parameters.

15. The device for displaying image signals as claimed in claim 12, further comprising a clock generator unit, for providing a reference clock for displaying the image signals on the display, based on said clock.

16. The device for displaying image signals as claimed in claim 11, further comprising a detection module, for generating a reading signal once receiving a Hot Plugging Detect Signal from a Digital Visual Interface (DVI), to control the reading module to read the display attributes information.

17. The device for displaying image signals as claimed in claim 11, further comprising a detection module, for generating a reading signal at predetermined time interval to control the reading module to read the display attributes information; the detection module determines whether the read display attributes information is valid or not by identifying a certain flag in the display attributes information.

18. The device for displaying image signals as claimed in claim 11, wherein the reading module reads the display attributes information via a Display Data Channel, and the display attributes information conforms to an Extended Display Identification Data specification.

19. A method for adaptively adjusting display parameters, comprising steps of:
(a) reading display attributes information from a connectable display;
(b) storing the display parameters for displaying image signals, the display parameters are configured based on the display attributes information; and
(c) controlling display timing for image signals to be displayed on the display according to the display parameters.

20. The method for adaptively adjusting display parameters as claimed in claim 19, wherein the display attributes information includes at least one of clock, display timing and resolution; the display parameters include at least one of horizontal scanning parameters and vertical scanning parameters generated based on the display attributes information.

21. The method for adaptively adjusting display parameters as claimed in claim 20, wherein the horizontal scanning parameters include Horizontal Resolution, Horizontal Active Duration, Horizontal Blanking Duration, Horizontal Sync Offset and Horizontal Sync Pulse Width; the vertical scanning parameters include Vertical Resolution, Vertical Active Duration, Vertical Blanking Duration, Vertical Sync Offset and Vertical Sync Pulse Width.

22. The method for adaptively adjusting display parameters as claimed in claim 21, wherein the step(c) comprises:
controlling horizontal scan process based on the horizontal scanning parameters; and
controlling vertical scan process based on the vertical scanning parameters.

23. The method for adaptively adjusting display parameters as claimed in claim 20, further comprising a step of providing a reference clock for displaying the image signals on the display, based on the clock.

24. The method for adaptively adjusting display parameters as claimed in claim 19, further comprising a step of:
reading the display attributes information once receiving a Hot Plugging Detect Signal from a DVI.

25. The method for adaptively adjusting display parameters according to claim 19, further comprising steps of:
reading the display attributes information at predetermined time interval; and
determining whether the read display attributes information is valid or not by identifying a certain flag in the display attributes information.

26. A method for displaying image signals, comprising steps of:
(a) reading display attributes information from a connectable display;
(b) providing corresponding display parameters for displaying the image signals based on the display attributes information;
(c) storing the display parameters;
(d) reading the stored display parameters; and
(e) controlling display timing for the image signals to be displayed on the display according to the read display parameters.

27. The method for displaying image signals as claimed in claim 26, wherein the display attributes information includes at least one of clock, display timing and resolution; the display parameters include at least one of horizontal scanning parameters and vertical scanning parameters generated based on the display attributes information.

28. The method for displaying image signals as claimed in claim 27, wherein the horizontal scanning parameters include Horizontal Resolution, Horizontal Active Duration, Horizontal Blanking Duration, Horizontal Sync Offset and Horizontal Sync Pulse Width; the vertical scanning parameters include Vertical Resolution, Vertical Active Duration, Vertical Blanking Duration, Vertical Sync Offset and Vertical Sync Pulse Width.

29. The method for displaying image signals as claimed in claim 27, wherein the step (e) comprises:
controlling horizontal scan process based on the horizontal scanning parameters; and controlling vertical scan process based on the vertical scanning parameters.

30. The method for displaying image signals as claimed in claim 27, further comprising a step of providing a reference clock for displaying the image signals on the display, based on said clock.

31. The method for displaying image signals as claimed in claim 26, further comprising a step of reading the display attributes information once receiving a Hot Plugging Detect Signal from a DVI.

32. The method for displaying image signals as claimed in claim 26, further comprising steps of:
reading the display attributes information at predetermined time interval; and
determining whether the read display attributes information is valid or not by identifying a certain flag in the display attributes information.
